(19) United States
(12) Patent Application Publication
(10) Pub. No.: US 2017/0200101 A1
(43) Pub. Date: Jul. 13, 2017

(54) SYSTEMS AND METHODS FOR OPTIMIZED TASK ALLOCATION

(71) Applicant: Tata Consultancy Services Limited, Mumbai (IN)

(72) Inventors: Rahul KUMAR, Pune (IN); Anand SRIRAMAN, Pune (IN); Mandar Shrikant KULKARNI, Pune (IN); Kanika KALRA, Pune (IN); Shirish Subhash KARANDE, Pune (IN); Sachin Premsukh LODHA, Pune (IN)

(73) Assignee: Tata Consultancy Services Limited, Mumbai (IN)

(21) Appl. No.: 15/400,297

(22) Filed: Jan. 6, 2017

(30) Foreign Application Priority Data
Jan. 7, 2016 (IN) 201621000651

(51) Int. Cl. G06Q 10/06; G06N 3/08

(52) U.S. Cl. CPC G06Q 10/06311; G06Q 10/067; G06N 3/08

(57) ABSTRACT

Optimizing task allocation requires taking into account cognitive load on workers and their response time to allocated tasks. The present disclosure provides for allocation of task by receiving data pertaining to current activity of workers; receiving data pertaining to at least one task to be allocated and determining activity-task pairs based on an activity feature vector corresponding to at least one human body part used during the current activity and a task feature vector corresponding to at least one human body part required for the at least one task to be performed by the workers. Cognitive load on the workers is then estimated for the determined activity-task pairs. An optimum activity-task pair based on the estimated cognitive load is determined and at least one task is allocated to the workers based on the determined optimum activity-task pair.

### PRIORITY CLAIM

This U.S. patent application claims priority under 35 U.S.C. §119 to: Indian Application No. 201621000651 filed on 7 Jan. 2016. The entire contents of the aforementioned application are incorporated herein by reference.

### TECHNICAL FIELD

The embodiments herein generally relate to task allocation, and more particularly to systems and methods for optimizing task allocation.

### BACKGROUND

End result of task allocation can be productive only if workers are responsive to the allocated tasks. Reduced productivity or incomplete tasks may be a result of workers being overloaded with tasks or not being receptive to particular tasks allocated to them. Not all workers are necessarily accountable and hence may lack motivation to perform allocated tasks. Human beings are capable of multiplexing. However, cognitive overloading due to task allocation without taking into account the current activity that is being performed by the worker leads to less than desired output from workers. Also, continually monitoring workers when performing various activities/tasks may not always be feasible.

### SUMMARY

Embodiments of the present disclosure present technological improvements as solutions to one or more of the above-mentioned technical problems recognized by the inventors in conventional systems.

In an aspect, there is provided a computer implemented method for optimized task allocation, the method comprising: receiving a first data pertaining to current activity of one or more workers; receiving a second data pertaining to at least one task to be allocated to the one or more workers; determining activity-task pairs based on an activity feature vector corresponding to at least one human body part used during the current activity by the one or more workers and a task feature vector corresponding to at least one human body part required for the at least one task to be performed by the one or more workers; estimating cognitive load on the one or more workers for the determined activity-task pairs; determining an optimum activity-task pair based on the estimated cognitive load; and allocating the at least one task to the one or more workers based on the determined optimum activity-task pair.

In another aspect, there is provided a system for optimized task allocation, the system comprising: one or more internal data storage devices comprising instructions; and one or more processors operatively coupled to the one or more internal data storage devices, the one or more processors being configured by the instructions to: receive a first data pertaining to current activity of one or more workers; receive a second data pertaining to at least one task to be allocated to the one or more workers; determine activity-task pairs based on an activity feature vector corresponding to at least one human body part used during the current activity by the one or more workers and a task feature vector corresponding to at least one human body part required for the at least one task to be performed by the one or more workers; estimate cognitive load on the one or more workers for the determined activity-task pairs; determine an optimum activity-task pair based on the estimated cognitive load; and allocate the at least one task to the one or more workers based on the determined optimum activity-task pair.

In an embodiment, estimating cognitive load comprises: obtaining a GOMS (a set of Goals, a set of Operators, a set of Methods for achieving the goals, and a set of Selections rules for choosing among competing methods for goals)-style goal sheet for each activity and task in the determined activity-task pairs; simulating the current activity and the allocated at least one task using a QN-MHP for the one or more workers based on the corresponding obtained GOMS-style goal sheet; and estimating an initial probability of completion of the at least one task allocated to the one or more workers based on a simulated time taken by the one or more workers.

In an embodiment, obtaining a GOMS-style goal sheet comprises one or more of (i) manually generating the GOMS-style goal sheet; (ii) using fNIRS (Functional near-infrared spectroscopy) scanners to detect brain activity; and (iii) using crowdsourcing inputs.

In an embodiment, using fNIRS scanners comprises: generating an ordered list of nodes of QN-MHP model for each activity and task in the determined activity-task pairs based on sequence of execution through the network thereof, the ordered list of nodes being based on the mapping of each of the nodes of the QN-MHP model with operators implemented therein and corresponding areas of human brain based on the detected brain activity by the fNIRS scanners associated with the one or more workers; and determining operators associated with each of the nodes.

In an embodiment, determining operators is based on crowdsourcing inputs.

In an embodiment, the method described herein above further comprises determining loops present in the sequence of execution and optimizing the obtained GOMS-style goal sheet.

In an embodiment, using crowdsourcing inputs comprises: allocating the at least one task and activity in the determined activity-task pairs to the one or more workers; mapping operators associated with each node of the QN-MHP model for each of the at least one task and activity based on votes received from the one or more workers, for the performed at least one task and activity; and aggregating the votes received to determine operators associated with each node based on majority voting.

In an embodiment, determining an optimum activity-task pair comprises: measuring time taken by the one or more workers to complete the allocated at least one task continually updating the estimated initial probability based on the measured time to generate updated probability associated with each of the determined activity-task pairs; generating a repository of the determined activity-task pairs mapped to the updated probability; and fetching an optimum activity-task pair from the generated repository.

In an embodiment, fetching an optimum activity-task pair comprises one of (i) fetching an activity-task pair having a maximum value for the initial probability or the updated probability for the one or more workers and correspondingly for the others thereof; (ii) fetching an activity-task pair based on a pre-determined optimum value for the initial probability or the updated probability of the one or more workers; and (iii) fetching an activity-task pair based on a maximum product of the initial probability or the updated probability of all the one or more workers.

In an embodiment, the one or more processors of the system described herein above are configured to perform the one or more methods described in various embodiments herein above.

In yet another aspect, there is provided a computer program product comprising a non-transitory computer readable medium having a computer readable program embodied therein, wherein the computer readable program, when executed on a computing device, causes the computing device to: receive a first data pertaining to current activity of one or more workers; receive a second data pertaining to at least one task to be allocated to the one or more workers; determine activity-task pairs based on an activity feature vector corresponding to at least one human body part used during the current activity by the one or more workers and a task feature vector corresponding to at least one human body part required for the at least one task to be performed by the one or more workers; estimate cognitive load on the one or more workers for the determined activity-task pairs; determine an optimum activity-task pair based on the estimated cognitive load; and allocate the at least one task to the one or more workers based on the determined optimum activity-task pair.

It is to be understood that both the foregoing general description and the following detailed description are exemplary and explanatory only and are not restrictive of the invention, as claimed.

### BRIEF DESCRIPTION OF THE DRAWINGS

The embodiments herein will be better understood from the following detailed description with reference to the drawings, in which:

FIG. 1 illustrates a block diagram of a system for optimizing task allocation in accordance with an embodiment of the present disclosure;

FIG. 2 is an exemplary flow diagram illustrating a computer implemented method for optimizing task allocation in accordance with an embodiment of the present disclosure; and

FIG. 3 illustrates a schematic representation of the architecture of QN-MHP (Queuing Network Model Human Processor) model as known in the art.

It should be appreciated by those skilled in the art that any block diagram herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computing system or processor, whether or not such computing system or processor is explicitly shown.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Some embodiments of this disclosure, illustrating all its features, will now be discussed in detail. The disclosed embodiments are merely exemplary of the disclosure, which may be embodied in various forms. Before setting forth the detailed explanation, it is noted that all of the discussion below, regardless of the particular implementation being described, is exemplary in nature, rather than limiting.

The expression “workers” in the present disclosure refers to one or more workers that can perform an allocated task. To ensure that allocated tasks are effectively performed, it is important to consider not only availability of workers, but also cognitive load on the workers based on the mental/physical activity that workers may already be engaged in. For a productive response, workers must be allocated most suitable tasks taking into account current activities that they may be engaged in. A productive output also requires workers ability and interest to complete allocated tasks. Monitoring them continually when they are engaged in an activity such as driving or such other activities that requires them to be mobile is a challenge. Thus optimizing task allocation by continually monitoring workers and dynamically modifying the allocated tasks based on workers response has been a challenge. Systems and methods of the present disclosure facilitate optimized task allocation by taking into account cognitive states, overall capacity of the human mind to multiplex, context and past history of workers to allocate tasks such that the likelihood of a task being completed in a desired manner is maximized.

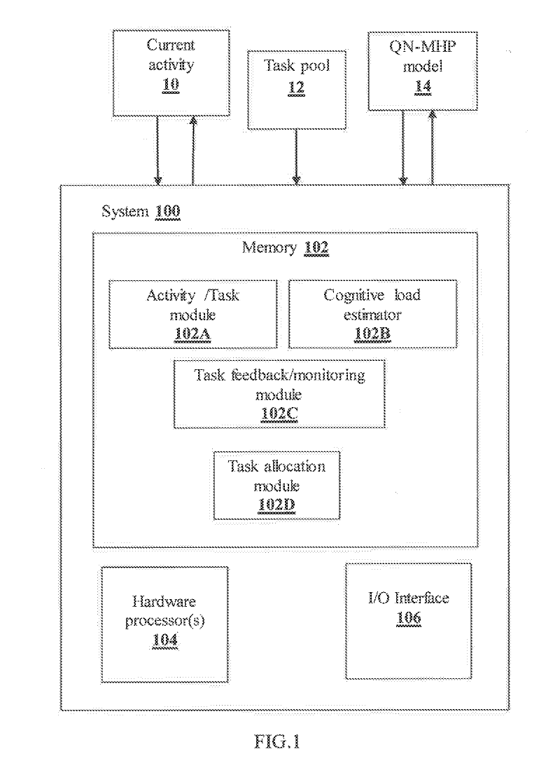

Referring now to the drawings, and more particularly to FIGS. 1 through 3, where similar reference characters denote corresponding features consistently throughout the figures, there are shown preferred embodiments and these embodiments are described in the context of the following exemplary device and method.

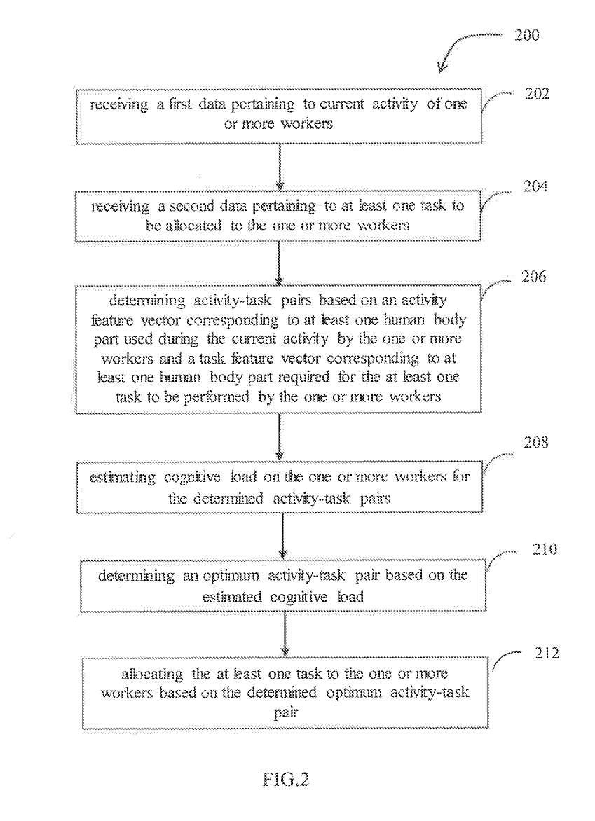

FIG. 1 illustrates a block diagram of a system 100 for optimized task allocation and FIG. 2 is an exemplary flow diagram illustrating a computer implemented method 200 for optimized task allocation, in accordance with an embodiment of the present disclosure.

In an embodiment, the system 100 includes one or more hardware processors 104, communication interface device or input/output (I/O) interface 106, and memory 102 or one or more internal data storage devices operatively coupled to the one or more processors. The one or more processors can be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory. In an embodiment, the system 100 can be implemented in a variety of computing systems, such as a laptop computer, a desktop computer, a notebook, a workstation, a mainframe computer, a server, a network server, cloud, hand-held device, wearable device and the like.

The I/O interface device 106 can include a variety of software and hardware interfaces, for example, a web interface, a graphical user interface, and the like and can facilitate multiple communications within a wide variety of networks and protocol types, including wired networks, for example, LAN, cable, etc., and wireless networks, such as WLAN, cellular, or satellite. In an embodiment, the I/O interface device 106 can include one or more ports for connecting a number of devices to one another or to another server.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, various modules 102A through 102D of the system 100 can be stored in the memory 102 as illustrated.

The steps of the computer implemented method 200 of the present disclosure will now be explained with reference to the components of the system 100 as depicted in FIG. 1. In an embodiment, at step 202, an Activity Detection Module 102A receives a first data pertaining to current activity 10 of one or more workers. For instance, the Activity Detection Module 102A can receive location, velocity and such other data from sensors such as accelerometer, gyroscope, compass, GPS, and the like associated with the one or more workers. In an embodiment, this data can be obtained from various devices on the one or more workers such as mobile phones, personal fitness monitors, smartwatches, and the like. The first data is used by the Activity Detection Module 102A to determine the current activity 10 that the one or more workers are engaged in such as resting, walking, jogging, sleeping, travelling, and the like. In an embodiment, the Activity Detection Module 102A can interface with a third party API to determine the current activity 10 of the one or more workers.

At step 204, a Task Allocation Module 102D receives a second data pertaining to at least one task, from a task pool 12, to be allocated to the one or more workers. For instance, tasks in the task pool 12 can include audio rating tasks, image tagging tasks, translation tasks, and the like.

At step 206, the Task Allocation Module 102D determines activity-task pairs based on an activity feature vector corresponding to at least one human body part used during the current activity by the one or more workers and a task feature vector corresponding to at least one human body part required for the at least one task to be performed by the one or more workers. In an embodiment, the Activity Detection Module 102A can interface with Human Actuator Detectors (not shown) for receiving a mapping of human actuators or human body parts available for task execution during an activity. In an embodiment, based on the current activity of the worker, the availability of the human actuators can be estimated manually, wherein workers input information about available actuators directly into the Activity Detection Module 102A. In another embodiment, based on pre-defined methods or rules and information pertaining to current activity, the Activity Detection Module 102A can estimate availability of the human actuators.

In an embodiment, the activity feature vector is a binary vector for each worker, wherein components of the vector are binary indicators (1 or 0) for the human body parts or human actuators such as Ears, Hands, Eyes, Fingers indicating whether the body parts are free/idle. Similarly, in an embodiment, the task feature vector is a binary vector, wherein components of the vector are binary indicators (1 or 0) for the human body parts or human actuators such as Ears, Hands, Eyes, Fingers indicating the body parts that are required to perform a task. In accordance with the present disclosure, these binary indicators are used to filter tasks that can be actually allocated to one or more workers. For instance, if the activity feature vector indicates that eyes and fingers are in use by a worker during a current activity of say driving, it may be feasible to assign an audio task to the worker depending on the cognitive load on the worker that is estimated by a Cognitive Load Estimator 102B. Thus, the Task Allocation Module 102D ensures that do-able activity-task pairs are determined for further estimating of cognitive load by the Cognitive Load Estimator 102B, thereby optimizing processor utilization.

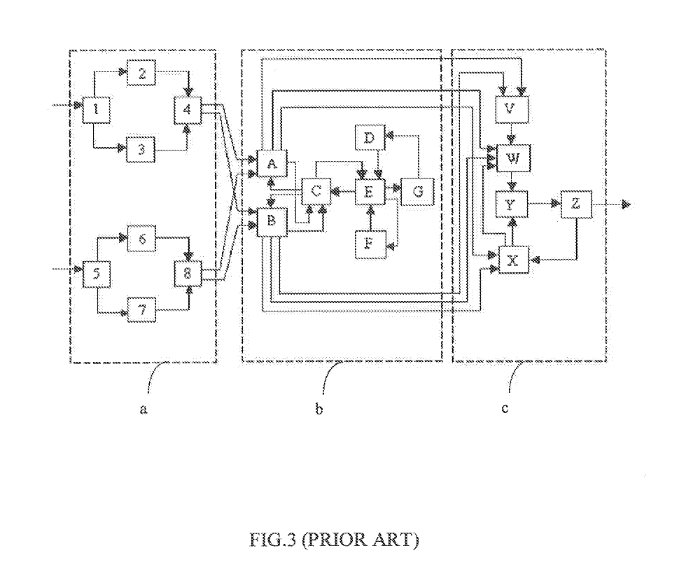

At step 208, the Cognitive Load Estimator 102B estimates cognitive load on the one or more workers for the activity-task pairs determined by the Task Allocation Module 102D. In an embodiment, the activity-task pairs are simulated using a QN-MHP (Queuing Network Model Human Processor) model 14. FIG. 3 illustrates a schematic representation of the computational architecture of QN-MHP (Queuing Network Model Human Processor) model as known in the art, wherein the computational architecture includes a perceptual subnetwork “a”, a cognitive subnetwork “b” and a motor subnetwork “c”. Stimuli enter the perceptual subnetwork “a” carrying perceptual information (visual and auditory input), which is then processed by the cognitive subnetwork “b” and converted into actions, carried out by the motor subnetwork “c”.

The processors of each subnetwork represent the following
1: common visual processing,
2: visual recognition,
3: visual location,
4: location and recognition integrator,
5: sound localization,
6: linguistic processing,
7: processing of other sounds,
8: linguistic and other sounds integrator,
A: visuospatial sketchpad,
B: phonological loop,
C: central executor,
D: goal procedures,
E: performance monitoring,
F: high level cognitive operations,
G: goal selection,
V: sensorimotor integration,
W: motor element storage,
X: movement tuning,
Y: motor programming, and
Z: actuators.

To simulate activity-task pairs in the QN-MHP model, it must be defined in a Natural GOMS Language (NGOMSL) style. This builds on the GOMS model which defines “a set of Goals, a set of Operators, a set of Methods for achieving the goals, and a set of Selections rules for choosing among competing methods for goals.” In accordance with the present disclosure, a GOMS-style goal sheet can be obtained by (i) manually generating the GOMS-style goal sheet; (ii) using fNIRS (Functional near-infrared spectroscopy) scanners to detect brain activity; (iii) using crowdsourcing inputs or a combination thereof.

There are 24 Operators representing “elementary perceptual, motor or cognitive acts” as defined by the QN-MHP model. Methods and selection rules are written in terms of these Operators for a given end Goal. Each node in the QN-MHP network is a computer which simulates a specific cognitive function and executes certain Operators. For e.g., the visual perception nodes (1-4) are responsible for the execution of visual operators like “Watch” which commands the eyes to watch for a particular object.

GOMS-style goal sheets can be generated for every supported task and activity. This annotation can be done by experts. Some examples of GOMS-style goal sheets generated manually for image labelling, translation and image transcription tasks, in accordance with an embodiment, are given herein below.

Method for GOAL: Label Image

1. Watch a label button

2. Move the mouse

3. Click the label button

4. Watch for label on the image
a. If Found:
   i. Move the cursor to label location
   ii. Click the left mouse button
   iii. Move hand until rectangle on screen encompasses label
   iv. Release the mouse

5. Retum with goal accomplished

Method for GOAL: translation

1. Reed text on screen

2. Identify phrase boundaries

3. For every phrase
a. Recall translation of phrase in required language from working memory
b. If not present in working memory, recall from long-term memory
c. Type the translated phrase

4. Read the translated text and compare with original text

5. Look for and correct adequacy omissions

6. Look for and correct alignment errors

7. Look for and correct grammatical mistakes.

8. Retum with goal accomplished

Method for GOAL: image transcription

1. Locate text in given image

2. For every character in text
a. Recall position of character on keyboard and corresponding finger
b. Move finger to press the key

3. Read typed text

4. Compare typed text with text in image
a. If mismatch, move mouse cursor to location of character mismatch
b. Press backspace key to remove offending character(s)
c. Type the correct character(s)

5. Retum with goal accomplished

The specific Operators, as defined in the QN-MHP model, are highlighted in bold italic font and are executed at various nodes on the QN-MHP network depending on where the operation is defined.

In an embodiment, GOMS-style goal sheets are obtained using fNIRS scanners by generating an ordered list of nodes of QN-MHP model for each activity and task in the determined activity-task pairs based on sequence of execution through the network. The ordered list of nodes are based on the mapping of each of the nodes of the QN-MHP model with Operators implemented therein and corresponding areas of human brain based on the detected brain activity by the fNIRS scanners associated with the one or more workers.

The fNIRS scanners detect changes in neural activity in the brain. In (fNIRS) scanners like the Brainput system (Solovey et al., 2012), the fNIRS scanners send light at two wavelengths in the near-infrared region which are reflected by oxygenated and deoxygenated hemoglobin molecules in the brain. These act as markers of neural activity in the brain. The amount of light reflected back at a particular region of the brain is indicative of the intensity of brain activity happening in that region. Every node in the QN-MHP network is mapped to a physical part of the brain. The following table shows this mapping:

| Node type | Nodes | Operators | Brain structure |
|---|---|---|---|
| Visual Processing | 1-4 | Glance, Watch, Compare, | Eye, LGN, SC, visual |
| | | Verify, Trigger, Locate, | pathway, Dorsal & |
| | | Identify | ventral system, |
| | | | distributed parallel |
| | | | area, superior frontal |
| | | | sulcus |
| Audio Processing | 5-8 | Listen, Listen for, Compare | Ear, Auditory pathway, |
| | | | Primary auditory |
| | | | cortex & planum |
| | | | temporale |
| Visuo-spatial | A | Image/Spatial memory | Posterior parietal |
| sketchpad | | access | cortex in right- |
| | | | hemisphere |
| Phonological Loop | B | Audio/Language memory | Left posterior parietal |
| | | access | cortex |
| Central Executive & | C | recall information from | Dorsal lateral |
| Memory Access | | working memory, retain | prefrontal cortex, |
| | | entity in working memory, | anterior cingulate |
| | | retrieve information from | cortex, Hippocampus |
| | | long term memory, and | |
| | | forget all retained entities | |
| Cognitive | F | select search target, | Left interior partial |
| Operators | | decide, compute, and time | cortex, IPS and VLFC |
| | | check | |
| Motor Subnetwork | V-Z | reach to target, move | Supplementary motor |
| | | object to target, apply | area and pre-SMA, |
| | | pressure to object, release | Primary motor cortex, |
| | | object, delay movement for | Basal ganglia |
| | | specified time | |

Since there are only a few operators defined at each node, by mapping brain activity measured by fNIRS scanners to a node in the QN-MHP network, the path of execution of a given task through the network can be determined and thus an ordered list of nodes are generated through which task execution takes place. In an embodiment, cycle-breaking algorithms are used to analyze the ordered list of nodes and determine loops for optimizing the goal sheets.

The ordered list of nodes refers to the nodes which are being utilized for execution of a task. However to determine a GOMS-style goal sheet for a task, it is required to filter out, based on the context, the Operators which are being used at each node step in the ordered list. For instance, if the visual cortex of the brain is being used, it is required to determine whether the “Locate” or the “Identify” operation is being performed. In an embodiment Operators associated with each of the nodes are determined using crowdsourcing inputs. Once the ordered list of nodes is generated, a crowdsourcing tagging exercise is initiated where workers are required to tag an Operator to a given node in the workflow given the type of task being performed by the workers is provided as additional information. Using a majority voting scheme, responses across multiple workers are aggregated to find an optimum estimate of Operator-Node mapping. Based on the determined Operators being used at every node in the ordered list, GOMS-style goal sheets for the task can be obtained without need for an expert to manually generate the same.

Alternatively, in an embodiment, GOMS-style goal sheets can be generated using crowdsourcing inputs by allocating at least one task and activity from the determined activity-task pairs to the one or more workers; mapping Operators associated with each node of the QN-MHP model for each of the tasks and activities based on votes received from the one or more workers; and aggregating the votes received to determine Operators associated with each node based on majority voting.

Once the determined activity-task pairs are simulated in the QN-MHP model, estimating the cognitive load includes a step of estimating an initial probability of completion of the task allocated to the worker based on a simulated time taken by the workers. The QN-MHP model estimates the total time a worker may take to complete the allocated task while being engaged in the current activity. The simulated time is converted into a probability measure about whether or not the worker will complete the task or not. Let the simulated time taken by a user i for crowd-sourcing task j during activity l be tᵢⱼₗ. Let, pᵢ(t) be the probability of worker i completing a task if the work is going to take time t. The probability function is continually updated on the basis of the success with which the task allocated to the worker is converted into actual work done. However for initialization, pᵢⱼ(t) is zero when t≧τᵢ, where τᵢ is a worker specific threshold. For all other values, an initialization function pᵢ(t)=e^{(-1/τ}^{ᵢ}⁾ can be used. Thus, for a specific task and context (activity) given the time estimate tᵢⱼₗ, the probability of an allocation being converted into actual work response from the worker is estimated as pᵢⱼ=p(tᵢⱼₗ)=e⁽⁻¹^{ᵢⱼₗ}^{/τ}^{ᵢ}⁾.

Once the cognitive load is estimated for the determined activity-task pairs, by the Cognitive load estimator 102B, at step 210, the Task Allocation Module 102D determines an optimum activity-task pair based on the estimated cognitive load. In accordance with the present disclosure, determining an optimum activity-task pair includes firstly measuring time taken by the worker to complete the allocated task. The initial probability is then continually updated by, a Task feedback/monitoring module 102C, based on the measured time to get an updated probability based on the following functions.

pᵢⱼ(t):=(1−λ)pᵢⱼ(t)+λ, if task is completed within time t

pᵢⱼ(t):=(1−λ)pᵢⱼ(t), if task is not completed within time t,

wherein λ is an update factor representing how fast the update occurs.

In an embodiment, a repository of the determined activity-task pairs mapped to the updated probability is generated. The optimum activity-task pair can be fetched from the repository based on a pre-determined strategy. Let the probabilities in the generated repository be represented by a matrix Q=[qᵢⱼ] where each element represents the probability of a task j being completed worker i. An exemplary matrix Q may be a 2D matrix as shown below—

$$Q = \begin{matrix}worker 1 \\ worker 2\end{matrix} {\{ \begin{matrix}0.7 & 0.8 & 0.9 \\ 0.5 & 0.6 & 0.7\end{matrix} \}}^{\begin{matrix}A & B & C\end{matrix}}$$

wherein 0.7, 0.8 and 0.9 represent the probability that worker 1 can complete tasks A, B and C respectively. Likewise, 0.5, 0.6, 0.7 represent the probability that worker 2 can complete tasks A, B and C respectively. The probability may be an initial probability when the worker is involved in an activity-task pair for the first time and the probability may be an updated probability when the worker is continually engaged in the activity-task pair and thereby having an updated probability of completion in the generated repository. In another embodiment, an activity-task pair having a maximum value for the probability may be fetched. In the above example, worker 1 may be allocated task C and accordingly, worker 2 would have to be allocated task B which is next maximum value of probability since task C is taken. In yet another embodiment, an activity-task pair based on a pre-determined optimum value for the probability may be fetched. In the above example, the pre-determined optimum value may be a globally optimum value which is 0.7. Thus, the lowest probability that the task may be completed is 0.7. In this example, worker 1 may be allocated task A and worker 2 may be allocated task C.
In yet another embodiment, an activity-task pair based on a maximum product of all the probabilities may be fetched. In the above example, tasks may be allocated based on the maximum product of 0.54 (0.9×0.6). Accordingly, worker 1 may be allocated task A and worker 2 may be allocated task B since task A is taken.

It may be understood that the modules and functions thereof referred in the description of the system of the present disclosure are purely exemplary. The system of the present disclosure comprises one or more processors that may be implemented as one or more modules for executing the one or more methods described herein above.

Thus, systems and methods of the present disclosure enables optimized task allocation based on the cognitive load on the workers. For instance, to optimize a worker's productivity, an audio rating task can be allocated if running is detected, switching to image tagging if walking is detected and further switching to translation if sitting is detected as current activity. Also, on continually monitoring of the worker, if it is observed that the worker does not show an inclination towards audio rating task on account of incompletion of the allocated task, such tasks can be substituted by any other task that is observed to be completed by the worker given the activity of running, thus optimizing the task allocation and improving productivity.

The written description describes the subject matter herein to enable any person skilled in the art to make and use the embodiments of the present disclosure. The scope of the subject matter embodiments defined here may include other modifications that occur to those skilled in the art. Such other modifications are intended to be within the scope if they have similar elements that do not differ from the literal language of the claims or if they include equivalent elements with insubstantial differences from the literal language.

It is, however to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The system may also include software means. Alternatively, the system of the present disclosure may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules comprising the device of the present disclosure and described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The various modules described herein may be implemented as software and/or hardware modules and may be stored in any type of non-transitory computer readable medium or other storage device. Some non-limiting examples of non-transitory computer-readable media include CDs, DVDs, BLU-RAY, flash memory, and hard disk drives.

Further, although process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It is intended that the disclosure and examples be considered as exemplary only, with a true scope and spirit of disclosed embodiments being indicated by the following claims.

What is claimed is:

1. A computer implemented method for optimized task allocation, the method comprising:
receiving a first data pertaining to current activity of one or more workers;
receiving a second data pertaining to at least one task to be allocated to the one or more workers;
determining activity-task pairs based on an activity feature vector corresponding to at least one human body part used during the current activity by the one or more workers and a task feature vector corresponding to at least one human body part required for the at least one task to be performed by the one or more workers;
estimating cognitive load on the one or more workers for the determined activity-task pairs;
determining an optimum activity-task pair based on the estimated cognitive load; and
allocating the at least one task to the one or more workers based on the determined optimum activity-task pair.

2. The computer implemented method of claim 1, wherein estimating cognitive load comprises:
obtaining a GOMS (a set of Goals, a set of Operators, a set of Methods for achieving the goals, and a set of Selections rules for choosing among competing methods for goals)-style goal sheet for each activity and task in the determined activity-task pairs, by one or more of (i) manually generating the GOMS-style goal sheet; (ii) using fNIRS (Functional near-infrared spectroscopy) scanners to detect brain activity; and (iii) using crowdsourcing inputs;
simulating the current activity and the allocated at least one task using a QN-MHP (Queuing Network Model Human Processor) model for the one or more workers based on the corresponding obtained GOMS-style goal sheet; and
estimating an initial probability of completion of the at least one task allocated to the one or more workers based on a simulated time taken by the one or more workers.

3. The computer implemented method of claim 2, wherein using fNIRS scanners comprises:
generating an ordered list of nodes of QN-MHP model for each activity and task in the determined activity-task pairs based on sequence of execution through the network thereof, the ordered list of nodes being based on the mapping of each of the nodes of the QN-MHP model with operators implemented therein and corresponding areas of human brain based on the detected brain activity by the fNIRS scanners associated with the one or more workers; and
determining operators associated with each of the nodes.

4. The computer implemented method of claim 3 further comprising determining loops present in the sequence of execution and optimizing the obtained GOMS-style goal sheet.

5. The computer implemented method of claim 3, wherein determining operators is based on crowdsourcing inputs and comprises:
allocating the at least one task and activity in the determined activity-task pairs to the one or more workers;
mapping operators associated with each node of the QN-MHP model for each of the at least one task and activity based on votes received from the one or more workers, for the performed at least one task and activity; and
aggregating the votes received to determine operators associated with each node based on majority voting.

6. The computer implemented method of claim 2, wherein determining an optimum activity-task pair comprises:
measuring time taken by the one or more workers to complete the allocated at least one task;
continually updating the estimated initial probability based on the measured time to generate updated probability associated with each of the determined activity-task pairs;
generating a repository of the determined activity-task pairs mapped to the updated probability; and
fetching an optimum activity-task pair from the generated repository.

7. The computer implemented method of claim 6, wherein fetching an optimum activity-task pair comprises one of (i) fetching an activity-task pair having a maximum value for the initial probability or the updated probability for the one or more workers and correspondingly for the others thereof; (ii) fetching an activity-task pair based on a pre-determined optimum value for the initial probability or the updated probability of the one or more workers; and (iii) fetching an activity-task pair based on the product of the initial probability or the updated probability of all the one or more workers.

8. A system for optimized task allocation, the system comprising:
one or more internal data storage devices comprising instructions; and
one or more processors operatively coupled to the one or more internal data storage devices, the one or more processors being configured by the instructions to:
receive a first data pertaining to current activity of one or more workers;
receive a second data pertaining to at least one task to be allocated to the one or more workers;
determine activity-task pairs based on an activity feature vector corresponding to at least one human body part used during the current activity by the one or more workers and a task feature vector corresponding to at least one human body part required for the at least one task to be performed by the one or more workers;
estimate cognitive load on the one or more workers for the determined activity-task pairs;
determine an optimum activity-task pair based on the estimated cognitive load; and
allocate the at least one task to the one or more workers based on the determined optimum activity-task pair.

9. The system of claim 8, wherein the one or more processors are further configured to:
obtain a GOMS (a set of Goals, a set of Operators, a set of Methods for achieving the goals, and a set of Selections rules for choosing among competing methods for goals)-style goal sheet for each activity and task in the determined activity-task pairs, by one or more of (i) manually generating the GOMS-style goal sheet; (ii) using fNIRS (Functional near-infrared spectroscopy) scanners to detect brain activity; and (iii) using crowdsourcing inputs;
simulate the current activity and the allocated at least one task using a QN-MHP (Queuing Network Model Human Processor) model for the one or more workers based on the corresponding obtained GOMS-style goal sheet; and
estimate an initial probability of completion of the at least one task allocated to the one or more workers based on a simulated time taken by the one or more workers.

10. The system of claim 9, wherein the one or more processors are further configured to use fNIRS scanners by:
generating an ordered list of nodes of QN-MHP model for each activity and task in the determined activity-task pairs based on sequence of execution through the network thereof, the ordered list of nodes being based on the mapping of each of the nodes of the QN-MHP model with operators implemented therein and corresponding areas of human brain based on the detected brain activity by the fNIRS scanners associated with the one or more workers; and
determining operators associated with each of the nodes.

11. The system of claim 10, wherein the one or more processors are further configured to determine loops present in the sequence of execution and optimize the obtained GOMS-style goal sheet.

12. The system of claim 9, wherein the one or more processors are further configured determine operators based on crowdsourcing inputs by:
allocating the at least one task and activity in the determined activity-task pairs to the one or more workers;
mapping operators associated with each node of the QN-MHP model for each of the at least one task and activity based on votes received from the one or more workers, for the performed at least one task and activity; and
aggregating the votes received to determine operators associated with each node based on majority voting.

13. The system of claim 9, wherein the one or more processors are further configured to determine an optimum-task pair by:
measuring time taken by the one or more workers to complete the allocated at least one task;
continually updating the estimated initial probability based on the measured time to generate updated probability associated with each of the determined activity-task pairs;
generating a repository of the determined activity-task pairs mapped to the updated probability; and
fetching an optimum activity-task pair from the generated repository.

14. The system of claim 13, wherein the one or more processors are further configured to fetch the optimum activity-task pair by one of (i) fetching an activity-task pair having a maximum value for the initial probability or the updated probability for the one or more workers and correspondingly for the others thereof; (ii) fetching an activity-task pair based on a pre-determined optimum value for the initial probability or the updated probability of the one or more workers; and (iii) fetching an activity-task pair based on a maximum product of the initial probability or the updated probability of all the one or more workers.

15. A computer program product comprising a non-transitory computer readable medium having a computer readable program embodied therein, wherein the computer readable program, when executed on a computing device, causes the computing device to:
receive a first data pertaining to current activity of one or more workers;
receive a second data pertaining to at least one task to be allocated to the one or more workers;
determine activity-task pairs based on an activity feature vector corresponding to at least one human body part used during the current activity by the one or more workers and a task feature vector corresponding to at least one human body part required for the at least one task to be performed by the one or more workers;
estimate cognitive load on the one or more workers for the determined activity-task pairs;
determine an optimum activity-task pair based on the estimated cognitive load; and
allocate the at least one task to the one or more workers based on the determined optimum activity-task pair.
